(19) United States
(12) Patent Application Publication
(10) Pub. No.: US 2026/0225965 A1
(43) Pub. Date: Aug. 6, 2026

(54) Mixed Stabilizer Thermal Barrier Coating

(71) Applicant: RTX Corporation, Farmington, CT (US)

(72) Inventors: Brian T. Hazel, Avon, CT (US); Elisa M. Zaleski, Vernon, CT (US); Baillie Rae Haddad, Dayville, CT (US); Richard Wesley Jackson, III, Mystic, CT (US)

(73) Assignee: RTX Corporation, Farmington, CT (US)

(21) Appl. No.: 19/151,474

(22) PCT Filed: Jan. 26, 2024
(86) PCT No.: PCT/US2024/013106

§ 371 Date: Jul. 28, 2025

Related U.S. Application Data
(60) Provisional application No. 63/441,421, filed on Jan. 26, 2023.

(51) Int. Cl. C04B 41/87; C04B 35/505; C04B 41/50

(52) U.S. Cl. CPC C04B 41/87; C04B 35/505; C04B 41/5042; C04B 41/5045; C04B 2235/3225; C04B 2235/3244

(57) ABSTRACT

A coated article (20) has: a substrate (22); a bond coat (26) deposited on the substrate; and a mixed stabilizer layer (30) positioned over the bond coat. The mixed stabilizer has matrix oxide(s) of one or more matrix tetravalent elements and stabilizer oxides of at least two stabilizer trivalent elements. The matrix elements are selected from a first group consisting of Zr, Hf, Ti, and Ce. The stabilizer elements are selected from a second group consisting of La, Ce, Pr, Nd, Sm, Eu, Gd, Tb, Dy, Ho, Er, Tm, Yb, Lu, Y, and Sc.

### CROSS-REFERENCE TO RELATED APPLICATION

Benefit is claimed of U.S. Patent Application No. 63/441,421, filed Jan. 26, 2023, and entitled “Mixed Stabilizer Thermal Barrier Coating”, the disclosure of which is incorporated by reference herein in its entirety as if set forth at length.

### BACKGROUND

The disclosure relates to high temperature ceramic coatings for gas turbine engines. More particularly, the disclosure relates to stabilized zirconia thermal barrier coatings (TBC).

Gas turbine engines (used in propulsion and power applications and broadly inclusive of turbojets, turboprops, turbofans, turboshafts, industrial gas turbines, and the like) include ceramic coatings used as thermal barrier coatings (TBC), environmental barrier coatings (EBC), abradable coatings, and the like. Example coated components include blades and vanes (collectively airfoil components or airfoil elements), combustor components (including combustor panels, bulkheads, cans, injectors, and the like), blade outer air seals (BOAS), and other components along the gaspath.

Example components include a substrate and a one or more layer coating system. Example substrates are metallic substrates, typically formed of nickel-based and/or cobalt-based superalloys (e.g., typically single-crystal (SX) in blades and combustor panels). Substrate material choice may be influenced by the particular component. Such material choice includes issues of both composition and microstructure (including associated casting or other manufacture techniques).

Example coating systems may include a bondcoat layer such as an aluminide or an MCrAlY. Example MCrAlY (where M is Ni and/or Co, optionally with Fe) are NiCoCrAlY or CoNiCrAlY such as NiCoCrAlYHfSi. One or more ceramic layers may be atop the bondcoat.

Example ceramic materials are stabilized zirconias, namely yttria-stabilized zirconia (YSZ) and gadolinia-stabilized zirconia (alternatively known as GdZ, GSZ, or GZO). Such materials may include blends (e.g., using combinations of gadolinia and yttria as stabilizers and/or including other additives). Example yttria-stabilized zirconia is 7 wt % YSZ. Example gadolinia-stabilized zirconia is Gd₂Zr₂O₇ or 59.5 wt % GSZ.

Discussed below, the solid phases of such ceramics include: fluorite (F); tetragonal (t); monoclinic (M); pyrochlore (P); delta (δ); and cubic (C). See, generally, FABRICHNAYA, O. ET AL., “Phase Equilibria and Thermodynamic Properties of the ZrO₂—GdO_{1.5}—YO_{1.5} System”, Journal of Phase Equilibria and Diffusion-J PHASE EQUILIB DIFFUS., December 2005, pp 591-604, Volume 26, No. 6, ASM International, Materials Park, OH.

An advantage of GSZ coatings is resistance to calcium-magnesium-alumino-silicate (CMAS—also known as “molten sand attack”) contaminants in the hot section of the engine. In operation a GSZ coating may react with liquid CMAS to form a reaction product baving a desirably stable apatite-type phase structure (nominally Ca₂Gd₈(SiO₄)₆O₂). Wenzhuo Deng and Jeffrey W. Fergus, “Effect of CMAS Composition on Hot Corrosion Behavior of Gadolinium Zirconate Thermal Barrier Coating Materials”, J, Electrochem. Soc., July 2017, pp C526-C531, Vol. 164, No. 9, The Electrochemical Society (ECS), Pennington, New Jersey. The apatite-type phase, in turn, can precipitate rapidly from the reaction between CMAS and GSZ and fill the open gaps in the coating microstructure at a rate that will limit the amount of infiltration CMAS into the coating and seal it from further CMAS infiltration. The resultant infiltrated thickness and sealing layer with the apatite-type phase is a fraction of the coating thickness affected in a material that is not beneficially reactive with CMAS like YSZ. US Patent Application Publication 20190078215 A1, “CMAS-RESISTANT THERMAL BARRIER COATING AND METHOD OF MAKING A COATING THEREOF”, Wessels et al., published 2019 Mar. 14.

Principal application techniques include electron beam physical vapor deposition (EB-PVD) and air plasma spray (APS). EB-PVD of GSZ has been observed to form gadolinium rich layers due to melt pool instabilities. Melt pool instabilities drive changes in deposited composition due to differences in constituent oxide vapor pressures. SCHULZ, U. ET AL., “Review on Advanced EB-PVD Ceramic Topcoats for TBC Applications”, International Journal of Applied Ceramic Technology, October 2004, pp 302-315, Vol. 1, No. 4, The American Ceramic Society, Columbus, OH. Melt pool instabilities may include beam arcs, changes in emission current, changes in beam zoom, focus, or position, or ingot instabilities. The result is a wide possible production run to production run range of Gd₂O₃ content at any depthwise point throughout the coating thickness yielding compositional banding of gadolinium-rich and gadolinium-depleted layers. Example variations may be at least +/−5 wt % (e.g., with nominal 59.5 wt % GSZ peaks at least 64.5 wt % and troughs at or below 54.5 wt %) but may be at least +/−10 wt % or more.

One prior art proposed solution to compositional banding is to aim for a lower gadolinium content such that gadolinium rich layers formed in the process do not yield the C phase. US Patent Application Publication 2020/0340100A1, “Thermal barrier coating with reduced stabilizer content”, Wessels et al., published Oct. 29, 2020. The challenge with this approach is that the mean gadolinium content will be lower. This may have detrimental effect on certain performance metrics. Top amongst those performance metrics is CMAS-resistance. At some minimum gadolinium content, the kinetics will be such that the GSZ material will not produce the blocking apatite phase fast enough to prevent infiltration into the open gaps of the coating. Once this kinetics race is lost then GSZ is expected to be more susceptible to CMAS attack than 7 wt % YSZ due to the lower fracture toughness of the GSZ material.

### SUMMARY

One aspect of the disclosure involves a ceramic coating comprising: matrix comprising oxide(s) of one or more matrix tetravalent elements; and stabilizer comprising oxides of at least two stabilizer trivalent elements. The matrix elements are selected from a first group consisting of Zr, Hf, Ti, and Ce. The stabilizer elements are selected from a second group consisting of La, Ce, Pr, Nd, Sm, Eu, Gd, Tb, Dy, Ho, Er, Tm, Yb, Lu, Y, and Sc. The oxides of the first group represent 30% to 70% single cation mole percent of the ceramic coating. The oxides of the second group represent 30% to 70% single cation mole percent of the ceramic coating. The combined oxides of the first and second groups matrix and stabilizer represent at least 90 weight percent of the coating. In the entirety of a temperature range of 1000° K to 2000° K the coating has: at least 50 volume percent flourite phase. A ratio of average stabilizer ionic radius to average matrix ionic radius is 1.430 to 1.450 with a stabilizer coordination number of eight and matrix coordination number of six. A disorder factor of the stabilizer is at least 0.020 measured as an average of the absolute value of the difference between a given said stabilizer ionic radius and the average said matrix ionic radius multiplied by the single-cation mole percentage that given stabilizer is of the overall stabilizer content.

In a further embodiment of any of the foregoing embodiments, additionally and/or alternatively, the stabilizer elements comprise: one or more large stabilizer elements defined as each having a ratio of said stabilizer ionic radius to average said matrix ionic radius of greater than or equal to 1.465 and forming at least 25.0 single cation mole percent of the stabilizer; and one or more small stabilizer elements defined as each having a ratio of said stabilizer ionic radius to average said matrix ionic radius of less than or equal to 1.415 and forming at least 25.0 single cation mole percent of the stabilizer.

In a further embodiment of any of the foregoing embodiments, additionally and/or alternatively, the stabilizer elements comprise: one or more intermediate stabilizer elements defined as each having a ratio of stabilizer ionic radius to average matrix ionic radius of >1.415 and <1.465 and forming at least 5.0 single cation mole percent of the stabilizer.

In a further embodiment of any of the foregoing embodiments, additionally and/or alternatively, in the entirety of the temperature range of 1000° K to 2000° K the coating has: at least 90 volume percent flourite phase.

In a further embodiment of any of the foregoing embodiments, additionally and/or alternatively, zirconium is the largest by single cation mole percent of the matrix elements and erbium is one of the two largest by single cation mole percent of the stabilizer elements.

In a further embodiment of any of the foregoing embodiments, additionally and/or alternatively, samarium or europium is the other of the two largest by single cation mole percent of the stabilizer elements.

In a further embodiment of any of the foregoing embodiments, additionally and/or alternatively, hafnium is the second largest by single cation mole percent of the matrix elements.

In a further embodiment of any of the foregoing embodiments, additionally and/or alternatively, hafnium is the largest by single cation mole percent of the matrix elements and yttrbium and/or erbium is one of the two largest by single cation mole percent of the stabilizer elements.

In a further embodiment of any of the foregoing embodiments, additionally and/or alternatively, zirconium or hafnium is the largest by single cation mole percent of the matrix elements; and yttrbium and/or erbium is one of the two largest by single cation mole percent of the stabilizer elements.

In a further embodiment of any of the foregoing embodiments, additionally and/or alternatively, zirconium is the largest by single cation mole percent of the matrix elements and yttrbium is one of the two largest by single cation mole percent of the stabilizer elements.

In a further embodiment of any of the foregoing embodiments, additionally and/or alternatively, the ratio of average stabilizer ionic radius to average matrix ionic radius is 1.435 to 1.445 and the disorder factor of the stabilizer is not more than 0.140.

In a further embodiment of any of the foregoing embodiments, additionally and/or alternatively, the ratio is 1.425 to 1.455.

In a further embodiment of any of the foregoing embodiments, additionally and/or alternatively, the disorder factor is 0.025 to 0.065.

In a further embodiment of any of the foregoing embodiments, additionally and/or alternatively, at least four of the stabilizer elements each format least 4.0 single cation mole percent of the stabilizer; and said at least four include at least one of erbium and ytterbium.

In a further embodiment of any of the foregoing embodiments, additionally and/or alternatively, the ceramic coating has a thickness of at least 25 micrometers.

In a further embodiment of any of the foregoing embodiments, additionally and/or alternatively, a gas turbine engine component includes the ceramic coating and further comprises a substrate (e.g., a metallic substrate such as a nickel-based superalloy).

In a further embodiment of any of the foregoing embodiments, additionally and/or alternatively, the gas turbine engine component further comprises a bondcoat between the substrate and the ceramic coating.

In a further embodiment of any of the foregoing embodiments, additionally and/or alternatively, the gas turbine engine component further comprises a YSZ layer between the bondcoat and the ceramic coating.

In a further embodiment of any of the foregoing embodiments, additionally and/or alternatively, a method for manufacturing the ceramic coating comprises EB-PVD from an ingot blend of the oxide(s) of one or more matrix elements and the oxides of at least two stabilizer elements.

In a further embodiment of any of the foregoing embodiments, additionally and/or alternatively, the method further comprises EB-PVD of a base ceramic layer.

In a further embodiment of any of the foregoing embodiments, additionally and/or alternatively, the EB-PVD from the ingot blend is over a thickness of at least 25 micrometers.

Another aspect of the disclosure involves a ceramic coating comprising: matrix comprising oxide(s) of one or more matrix tetravalent elements; and stabilizer comprising oxides of at least two stabilizer trivalent elements. A ratio of average stabilizer ionic radius to average matrix ionic radius is 1.430 to 1.450 with a stabilizer coordination number of eight and matrix coordination number of six. A disorder factor of the stabilizer is at least 0.020 measured as an average of the absolute value of the difference between a given said stabilizer ionic radius and the average said matrix ionic radius multiplied by the single-cation mole percentage that given stabilizer is of the overall stabilizer content.

In a further embodiment of any of the foregoing embodiments, additionally and/or alternatively, in the entirety of a temperature range of 1000° K to 2000° K the coating has at least 50 volume percent flourite phase.

In a further embodiment of any of the foregoing embodiments, additionally and/or alternatively, the matrix elements are selected from a first group consisting of Zr, Hf, Ti, and Ce. The stabilizer elements are selected from a second group consisting of La, Ce, Pr, Nd, Sm, Eu, Gd, Tb, Dy, Ho, Er, Tm, Yb, Lu, Y, and Sc. The oxides of the first group represent 30% to 70% single cation mole percent of the ceramic coating. The oxides of the second group represent 30% to 70% single cation mole percent of the ceramic coating. The combined oxides of the first and second groups matrix and stabilizer represent at least 90 weight percent of the coating.

Another aspect of the disclosure involves a ceramic coating comprising: matrix comprising oxide(s) of one or more matrix elements; and stabilizer comprising oxides of at least two stabilizer elements. The stabilizer provides means for stabilizing flourite phase in the entirety of a temperature range of 1000° K to 2000° K and/or means for providing the coating with at least 50 volume percent flourite phase in the entirety of a temperature range of 1000° K to 2000° K.

In a further embodiment of any of the foregoing embodiments, additionally and/or alternatively, the matrix elements are tetravalent elements and the stabilizer elements are trivalent elements.

In a further embodiment of any of the foregoing embodiments, additionally and/or alternatively, a ratio of average stabilizer ionic radius to average matrix ionic radius is 1.430 to 1.450 with a stabilizer coordination number of eight and matrix coordination number of six. A disorder factor of the stabilizer is at least 0.020 measured as an average of the absolute value of the difference between a given said stabilizer ionic radius and the average said matrix ionic radius multiplied by the single-cation mole percentage that given stabilizer is of the overall stabilizer content.

Another aspect of the disclosure involves a coated article comprising: a substrate; a bond coat deposited on the substrate; and a mixed stabilizer layer positioned over the bond coat. The mixed stabilizer comprises matrix oxide(s) of one or more matrix tetravalent elements and stabilizer oxides of at least two stabilizer trivalent elements. The matrix elements are selected from a first group consisting of Zr, Hf, Ti, and Ce. The stabilizer elements are selected from a second group consisting of La, Ce, Pr, Nd, Sm, Eu, Gd, Tb, Dy, Ho, Er, Tm, Yb, Lu, Y, and Sc. The mixed stabilizer layer has a thickness of at least 100 micrometers. Further embodiments may be as described above or below.

In a further embodiment of any of the foregoing embodiments, additionally and/or alternatively, the mixed stabilizer layer is directly on the bondcoat.

In a further embodiment of any of the foregoing embodiments, additionally and/or alternatively, a ceramic base layer is between the bondcoat and the mixed stabilizer layer.

In a further embodiment of any of the foregoing embodiments, additionally and/or alternatively, the ceramic base layer is a YSZ layer.

In a further embodiment of any of the foregoing embodiments, additionally and/or alternatively: at least four of the stabilizer elements each form at least 4.0 single cation mole percent of the stabilizer; and said at least four include at least one of erbium and ytterbium.

In a further embodiment of any of the foregoing embodiments, additionally and/or alternatively: zirconium is the largest by single cation mole percent of the matrix elements; and erbium is one of the two largest by single cation mole percent of the stabilizer elements.

In a further embodiment of any of the foregoing embodiments, additionally and/or alternatively: samarium or europium is the other of the two largest by single cation mole percent of the stabilizer elements.

In a further embodiment of any of the foregoing embodiments, additionally and/or alternatively: hafnium is the second largest by single cation mole percent of the matrix elements.

In a further embodiment of any of the foregoing embodiments, additionally and/or alternatively: hafnium is the largest by single cation mole percent of the matrix elements; and yttrbium and/or erbium is one of the two largest by single cation mole percent of the stabilizer elements.

In a further embodiment of any of the foregoing embodiments, additionally and/or alternatively: zirconium is the largest by single cation mole percent of the matrix elements; and ytterbium is one of the two largest by single cation mole percent of the stabilizer elements.

In a further embodiment of any of the foregoing embodiments, additionally and/or alternatively: zirconium or hafnium is the largest by single cation mole percent of the matrix elements; and yttrbium and/or erbium is one of the two largest by single cation mole percent of the stabilizer elements.

In a further embodiment of any of the foregoing embodiments, additionally and/or alternatively, the mixed stabilizer layer has a thickness of 100 micrometers to 500 micrometers.

Another aspect of the disclosure involves a method for manufacturing a coated article, the method comprising: depositing a bond coat on a substrate; and depositing a mixed stabilizer layer over the bond coat. The mixed stabilizer layer comprises matrix oxide(s) of one or more matrix tetravalent elements and stabilizer oxides of at least two stabilizer trivalent elements. The matrix elements are selected from a first group consisting of Zr, Hf, Ti, and Ce. The stabilizer elements are selected from a second group consisting of La, Ce, Pr, Nd, Sm, Eu, Gd, Tb, Dy, Ho, Er, Tm, Yb, Lu, Y, and Sc. The mixed stabilizer layer has a thickness of at least 100 micrometers. Further embodiments may be as described above or below.

A further embodiment of any of the foregoing embodiments may additionally and/or alternatively include applying a ceramic base layer on the bondcoat before applying the mixed stabilizer layer.

A further embodiment of any of the foregoing embodiments may additionally and/or alternatively include the stabilizer oxides corresponding to the stabilizers of at least one example of Table I without reference to concentration but each present in at least 5.0 single cation mole percent.

A further embodiment of any of the foregoing embodiments may additionally and/or alternatively include there being no additional stabilizer oxide at concentration above 1.0 single cation mole percent.

A further embodiment of any of the foregoing embodiments may include the stabilizer oxides corresponding to the stabilizers of at least one example of Table I in concentrations +/−3.0 single cation mole percent from the nominal value of such example(s). In other such embodiments, the concentration of each said Table I stabilizer may be within +/−20% or 10% of the relative content of such stabilizer to all the listed stabilizers of such example. For example, such a relative +/−10% variation in an example with 50% matrix and 50% stabilizer and 10% of a given stabilizer would be +/−2.0% of that given stabilizer because such stabilizer nominal composition is 20% of the total stabilizer. This may be particularly relevant to address variations in relative stabilizer and matrix content.

In further variations, by-weight concentration may correspond to that dictated by the nominal single-cation mole concentration of examples of Table I. And there may be compositional percentage variations of the same weight percentages as discussed for single-cation mole percentages.

The features of the embodiments above or below may be combined in any combination unless expressly indicated otherwise or technically infeasible.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a schematic cross-sectional view of a coating system.

Like reference numbers and designations in the various drawings indicate like elements.

### DETAILED DESCRIPTION

Some gadolinium-rich layers have been found to be susceptible to premature failure in engine test and field operation characterized by horizontal cracking.

Not all gadolinium-rich layers in the coating thickness are subject to cracking. From observations to this point, it appears that the cracking is occurring lower in the coating thickness as opposed to near the hot surface. When viewing the zirconia-gadolinia phase diagram there are differences in the phases that are stable at elevated gadolinium content. Specifically, we believe the presence of the Gd₂O₃ “C” phase is needed to increase the propensity for cracking at the rates seen in the engine. This phase is suppressed in GSZ above a certain temperature where the flourite phase is stable but below about eutectoid reaction at about 1850° F. (1010° C.) (see Fabrichnaya et al. above) the “C” phase can be present as a solid solution with “P” pyrochlore phase above 50 single cation mole %.

We propose to use a mixed stabilizer (gadolinium being the stabilizer in a baseline GSZ) content at the same total stabilizer level as the pyrochlore GSZ baseline noted above but which suppresses the C phase. Different stabilizers can be used to stabilize the P, F, or delta phase. Specifically, a multi-stabilizer system is envisioned to provide stable fluorite phase over a broad temperature range in a ceramic coating material.

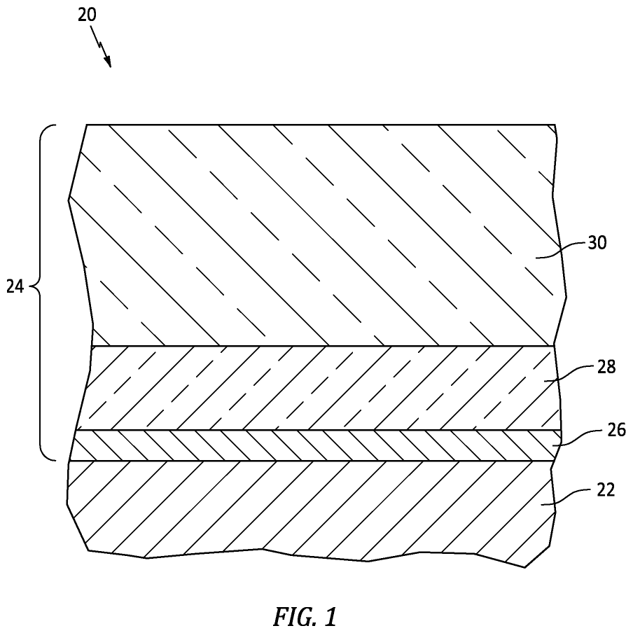

FIG. 1 shows an article 20 comprising a coated substrate 22. Example articles are turbine engine components as noted above. At least at the particular location, a coating system 24 comprises a bondcoat (e.g., an MCrAlY bondcoat applied by physical vapor deposition, plasma spray, or cathodic arc) 26. A ceramic base layer 28 is atop the bondcoat. An example base layer is YSZ (e.g., 7YSZ applied by EB-PVD and functioning to provide a durable interface layer that improves bond quality). The mixed stabilizer layer 30 is atop the YSZ and may be applied by vapor deposition (e.g., electron beam physical vapor deposition (EB-PVD)).

An example thickness of the base layer if present is about 25 micrometers, more broadly 5.0 to 100 micrometers or 10.0 to 50 micrometers. An example thickness of the mixed stabilizer layer is 200 to 300 micrometers, more broadly, at least 100 micrometers or at least 25 micrometers, or an example 100 micrometers to 375 micrometers or 100 micrometers to 500 micrometers or 25 micrometers to 1000 micrometers.

The coating and layer thickness, composition, and properties may be measured at a single location or across an area. Such area may be a total or continuous area (e.g., truly continuous or continuous ignoring cooling hole outlets). With an area, that may be at all locations or an average (mean), or median, or mode. A representative area is at least 1.0 square centimeters.

Or, a representative area may be a fraction or percentage of a relevant area. For example, the relevant area may be the gaspath-facing surface of a component for a thermal barrier coating or the inner diameter face of a blade outer air seal for an abradable coating system. For a TBC on a blade (e.g., having attachment root (e.g., firtree or dovetail), airfoil, and optional intervening platform), the relevant area includes pressure and suction side surfaces of the airfoil and the gaspath-facing facing outer diameter surface of the platform. For a non-cantilever vane, it would include such airfoil surfaces, and platform (inner diameter (ID) shroud) and outer diameter (OD) shroud gaspath-facing surfaces (OD and ID respectively). A cantilever vane would typically lack the ID shroud. A combustor panel may be formed as a generally frustoconical segment for an annular combustor where the relevant area would be the ID face of an OD panel or the OD face of an ID panel. Example combustor panel substrates would include threaded mounting studs protruding from the surface opposite the gas path-facing surface. A representative such fraction or percentage is at least 10% or at least 50% or at least 90%. Depthwise, a specified composition may be present at a single location or over a range such as the entirety of the relevant layer thickness specified or may be measured as an average (mean), or median, or mode across the specified thickness.

In this illustrated example, the mixed stabilizer layer 30 is the uppermost/topmost layer. However, other layerings are possible. These may include adding a further layer such as a topcoat or an abradable layer atop the mixed stabilizer layer (either with or without any base layer 28). Other variations may also avoid the base layer. Other variations may include compositional gradations between layers.

Additionally, there may be graded compositions wherein the relative contents of the matrix element(s) and stabilizers may vary depthwise within what is otherwise a single layer (e.g., a continuous variation or small stepwise variations). In various implementations, the mixed stabilizer layer may be used in a reengineering of an existing/baseline coating system such as in a retrofit situation wherein an engine part having the existing/baseline coating system is replaced with one having the modified system or is restored using the modified system. In one group of such situations may therefore involve a multi-layer baseline wherein a GSZ layer is replaced with a mixed stabilizer layer but other layer(s) are preserved relative to the baseline.

Regarding stabilizer selection, we note that Levi disclosed a transition in the lanthanide series between pyrochlore-dominated and delta-dominated structure. CARLOS G. LEVI, “Emerging Materials and Processes for Thermal Barrier Systems”, Current Opinion in Solid State and Materials Science, January 2004, Pages 77-91, Volume 8, Issue 1, Elsevier Ltd, Amsterdam, Netherlands. La through Gd with larger ionic radii stabilize the P phase while Ho through Lu with smaller ionic radii stabilize the delta phase. Interestingly Tb and Dy have the potential for both to be stable.

Fabrichnaya et al. (above) showed that a Gd—Y mixed stabilizer could suppress the P or delta phase and stabilize F. We believe that other mixed stabilizers can suppress: (1) narrow pyrochlore and delta phase fields at lower equilibrium temperatures; and (2) the resulting adjacent two-phase field especially that includes “C” phases. By stabilizing the fluorite single phase field, the range of stabilizer contents that are single phase fluorite and do not contain the stabilizer rich “C” phase is wide compared to the stabilizer range induced by process variation.

The stabilization is believed to correlate with certain relationships of ionic radii of the stabilizer elements and base ceramic element(s). For example, in a basic gadolinia-stabilized zirconia, the single stabilizer element is gadolinium and the single base element is zirconium. In a binary stabilizer situation involving a gadolinia-yttria combination, gadolinium and yttrium are the stabilizer elements.

The ceramic system is a cubic fluorite structure that is an interpenetration of a cubic oxygen lattice in the middle of a face-centered cubic lattice. ZrO₂ and HfO₂ form a distorted or monoclinic fluorite. The face-centered cubic lattice is doped with the stabilizer to stabilize the cubic fluorite structure by increasing the oxygen vacancy concentration. The stabilizers are trivalent elements (Zr and Hf are tetravalent) which create the oxygen vacancy. The primary face-centered cubic lattice element(s) (tetravalent element or elements), are defined as the matrix element. The doping element(s) (trivalent element or elements) are defined as the stabilizer element. The mixed stabilizer ceramic system has one or more matrix elements and two or more stabilizer elements. The matrix elements are Zr, Hf, Ti, and Ce. The stabilizer elements are La, Ce, Pr, Nd, Sm, Eu, Gd, Tb, Dy, Ho, Er, Tm, Yb, Lu, Y, and Sc. Ce is unique in that its valency can be either +3 or +4 and therefore can act as a matrix and/or a stabilizer depending on what it is combined with.

The average ionic radii (rA) of the stabilizers is defined as the sum over all stabilizers of the product of the ionic radius of that stabilizer and that stabilizer's single-cation mole percentage of all stabilizers. In examples below, this is measured with a stabilizer coordination number of eight. SUBRAMANIAN, M. A., ET AL., “Oxide Pyrochlores—A Review”, Progress in Solid State Chemistry, January 1983, pp. 55-143, vol. 15, no. 2, Pergamon Press Ltd. London, United Kingdom.

The average ionic radii (rB) of the matrix is defined as the sum over all matrix base elements of the product of the ionic radius of that base element and that base element's single-cation mole percentage of all matrix. In examples below, this is measured with a matrix coordination number of six (Subramanian et al. above).

A disorder factor reflects the sum of the differences between each stabilizer ionic radius and some characteristic radius weighted by the mole fraction of each stabilizer. An example characteristic radius is the average matrix ionic radius rB. An example denominator for the mole fraction is total stabilizer content rather than matrix plus stabilizer. Thus, that example disorder factor measure represents an average of the absolute value of the difference between a given stabilizer ionic radius and the average matrix ionic radius multiplied by the single-cation mole percentage that given stabilizer is of the overall stabilizer content. An example disorder factor value using this particular measure is at least (greater than or equal to) 0.020, more preferably, 0.020 to 0.140, or 0.025 to 0.070, or 0.025 to 0.065, or 0.030 to 0.070 or 0.030 to 0.065.

An example rA/rB ratio is 1.425 to 1.455, more narrowly, 1.430 to 1.450 or 1.435 to 1.445.

The stabilizers may be divided by size (ionic radii). An example involves “small”, “intermediate” and “large”. These may be measured relative to the average rB. For small stabilizers, individual rA may be less than or equal to 1.415 average rB (e.g., more narrowly with a lower end 1.200 to 1.415). For large stabilizers, individual rA may be greater than or equal to 1.465 average rB (e.g., more narrowly with an upper end 1.465 to 1.920). For intermediate stabilizers, 1.415 average rB<individual rA<1.465 average rB.

An example distribution may have small and large each as at least 25.0% of total stabilizer by single cation mole percent (e.g., 25.0% to 75.0% or 25.0% to 70.0%). It is seen that this relates to the disorder factor in that a larger disorder factor is obtained with larger differences in stabilizer ionic radii and similar amounts of large and small stabilizers. More specifically, particularly in binary systems, each may have at least 30.0%. The intermediate element(s) if present may be in any otherwise appropriate amount. Examples of significant content are at least 5.0 weight percent of the total stabilizer (e.g., 5.0% to 40.0% or 5.0% to 30.0%).

Table I below contains examples of zirconia matrix and hafnia matrix and several stabilizer systems. In these examples, the single cation mole percent of matrix is 50% and rA/rB is 1.440. As noted above the proportions may be altered within the rA/rB ranges noted.

TABLE I

| | Oxide Chemistry | | | | | | | | | | | | Average | | |
|---|---|---|---|---|---|---|---|---|---|---|---|---|---|---|---|
| | | Stabilizer | | | | | Single cation mole % | | | | | | Radius | | |
| Ex. | Matrix | 1st | 2nd | 3rd | 4th | 5th | matrix | 1st | 2nd | 3rd | 4th | 5th | rA | rA/rB | Disorder |
| 1 | ZrO₂ | ErO_{1.5} | SmO_{1.5} | | | | 50 | 28 | 22 | | | | 1.037 | 1.440 | 0.037 |
| 2 | ZrO₂ | ErO_{1.5} | EuO_{1.5} | | | | 50 | 24 | 26 | | | | 1.037 | 1.440 | 0.031 |
| 3 | ZrO₂ | HoO_{1.5} | EuO_{1.5} | | | | 50 | 29 | 21 | | | | 1.036 | 1.439 | 0.025 |
| 4 | ZrO₂ | YbO_{1.5} | NdO_{1.5} | | | | 50 | 29 | 21 | | | | 1.037 | 1.440 | 0.060 |
| 5 | ZrO₂ | YbO_{1.5} | PrO_{1.5} | | | | 50 | 32 | 18 | | | | 1.037 | 1.440 | 0.066 |
| 6 | ZrO₂ | DyO_{1.5} | YbO_{1.5} | NdO_{1.5} | | | 50 | 15 | 19 | 16 | | | 1.037 | 1.440 | 0.046 |
| 7 | ZrO₂ | DyO_{1.5} | YbO_{1.5} | PrO_{1.5} | | | 50 | 15 | 21 | 14 | | | 1.037 | 1.440 | 0.050 |
| 8 | ZrO₂ | DyO_{1.5} | HoO_{1.5} | EuO_{1.5} | | | 50 | 16.7 | 16.7 | 16.7 | | | 1.036 | 1.439 | 0.020 |
| 9 | ZrO₂ | DyO_{1.5} | ErO_{1.5} | SmO_{1.5} | | | 50 | 16.7 | 16.7 | 16.7 | | | 1.037 | 1.440 | 0.028 |
| 10 | ZrO₂ | GdO_{1.5} | YbO_{1.5} | NdO_{1.5} | | | 50 | 15 | 22 | 13 | | | 1.037 | 1.440 | 0.046 |
| 11 | ZrO₂ | GdO_{1.5} | YbO_{1.5} | PrO_{1.5} | | | 50 | 15 | 24 | 11 | | | 1.037 | 1.440 | 0.049 |
| 12 | ZrO₂ | EuO_{1.5} | YbO_{1.5} | NdO_{1.5} | | | 50 | 15 | 24 | 11 | | | 1.037 | 1.440 | 0.050 |
| 13 | ZrO₂ | EuO_{1.5} | YbO_{1.5} | PrO_{1.5} | | | 50 | 15 | 25 | 10 | | | 1.037 | 1.440 | 0.052 |
| 14 | ZrO₂ | DyO_{1.5} | EuO_{1.5} | ErO_{1.5} | SmO_{1.5} | | 50 | 15 | 10 | 16 | 9 | | 1.037 | 1.440 | 0.027 |
| 15 | ZrO₂ | DyO_{1.5} | EuO_{1.5} | YbO_{1.5} | NdO_{1.5} | | 50 | 15 | 10 | 16 | 9 | | 1.037 | 1.440 | 0.031 |
| 16 | ZrO₂ | SmO_{1.5} | YbO_{1.5} | ErO_{1.5} | EuO_{1.5} | | 50 | 13 | 12 | 11 | 14 | | 1.037 | 1.440 | 0.043 |
| 17 | ZrO₂ | NdO_{1.5} | YbO_{1.5} | ErO_{1.5} | SmO_{1.5} | | 50 | 10 | 15 | 13 | 12 | | 1.037 | 1.440 | 0.051 |
| 18 | ZrO₂ | DyO_{1.5} | SmO_{1.5} | YbO_{1.5} | ErO_{1.5} | EuO_{1.5} | 50 | 10 | 10 | 9 | 9 | 12 | 1.035 | 1.438 | 0.032 |
| 19 | HfO₂ | ErO_{1.5} | EuO_{1.5} | | | | 50 | 35 | 15 | | | | 1.022 | 1.440 | 0.026 |
| 20 | HfO₂ | YbO_{1.5} | GdO_{1.5} | | | | 50 | 22 | 28 | | | | 1.022 | 1.440 | 0.034 |
| 21 | HfO₂ | YbO_{1.5} | EuO_{1.5} | | | | 50 | 27 | 23 | | | | 1.022 | 1.440 | 0.040 |
| 22 | HfO₂ | YbO_{1.5} | SmO_{1.5} | | | | 50 | 30 | 20 | | | | 1.022 | 1.440 | 0.045 |
| 23 | HfO₂ | DyO_{1.5} | YbO_{1.5} | SmO_{1.5} | | | 50 | 15 | 22 | 13 | | | 1.022 | 1.440 | 0.033 |
| 24 | HfO₂ | ErO_{1.5} | EuO_{1.5} | YbO_{1.5} | SmO_{1.5} | | 50 | 16 | 9 | 16 | 9 | | 1.022 | 1.440 | 0.031 |
| 25 | HfO₂ | ErO_{1.5} | GdO_{1.5} | YbO_{1.5} | SmO_{1.5} | | 50 | 16 | 10 | 15 | 9 | | 1.022 | 1.440 | 0.028 |
| 26 | HfO₂ | ErO_{1.5} | GdO_{1.5} | YbO_{1.5} | EuO_{1.5} | | 50 | 13 | 12 | 15 | 10 | | 1.022 | 1.440 | 0.029 |

Regarding matrix variations, one particular variation is a partial or full substitution of hafnia for zirconia, broader ranges of matrix around the 50% nominal are 45% to 55%, 40% to 60%, and 30% to 70%.

Other matrix variations include TiO₂, CeO₂, or mixtures of any. Matrix may include up to 100% of any matrix element or be mixtures of any.

Regarding example stabilizer variations, the table primarily uses Er and Yb as the small ionic radii stabilizers but other small stabilizers like Ho, Tm, Lu, or Sc could be used in whole or part. The table also primarily uses Sm, Eu, Nd, or Pr as the large ionic radii stabilizers but other large stabilizers like La, Ce, or Gd (Gd in the case of Hf matrix only) could be used in whole or part. Intermediate radii stabilizers like Gd, Tb, and/or Dy for a matrix of Zr or Tb, Dy, and/or Ho for a matrix of Hf could also be used in part.

There may be variations on the relative or absolute stabilizer content from the specific Table I examples. Also, there may be additional intended components or unavoidable impurities. In some variant examples, the combined content of Table I matrix (or such substitution as discussed above) and stabilizer may account for at least 90% or at least 95% or at least 99% by weight or single cation mole percentage of the relevant coating layer or sublayer. In some such variant examples, there may be no additional stabilizer oxide above 1.0 single cation mole percent. Variations on each Table I example may have its listed stabilizers present in concentrations of at least 5.0 single cation mole percent or at least 8.0 single cation mole percent. And the matrix may represent the largest weight or single cation mole content.

Other or such variations may include the stabilizer oxides corresponding to the stabilizers of at least one example of Table I in concentrations +/−3.0 single cation mole percent from the nominal value of such example(s). In other such embodiments, the concentration of each said Table I stabilizer may be within +/−20% or 10% of the relative content of such stabilizer to all the listed stabilizers of such example. For example, such a relative +/−10% variation in an example with 50% matrix and 50% stabilizer and 10% of a given stabilizer would be +/−2.0% of that given stabilizer because such stabilizer nominal composition is 20% of the total stabilizer. This may be particularly relevant to address variations in relative stabilizer and matrix content.

In further variations, by-weight concentration may correspond to that dictated by the nominal single-cation mole concentration of examples of Table I. And there may be compositional percentage variations of the same weight percentages as discussed for single-cation mole percentages.

EB-PVD of the mixed stabilizer layer may be from a single ingot or multiple ingots. If multiple, they may be of a single composition or different respective compositions to yield the final desired composition. If a single composition, the ingot may be made by blending the oxide(s) of the one or more matrix elements and the oxides of the at least two stabilizer elements.

Example stabilization of the flourite phase is at least 50 volume percent of the ceramic, more particularly at least 70 or at least 80 or at least 90. Example upper limits are 100 volume percent, 99 volume percent, 95 volume percent, 90 volume percent, and 80 volume percent with any of these where numerically possible. This volume percent is of the ceramic and does not include large scale porosity within the layer or filler within the layer such as abrasive. This may exist in the entirety of a temperature range of 1000° K to 2000° K in vacuum or ambient air or inert gas. In typical EB-PVD coatings, the large-scale porosity is less than 15 volume percent and there is no abrasive. Thus, the numbers above may be used in alternative examples of overall flourite in the layer for such low porosity situations.

In other variations, the substrate may be other than metallic (e.g., a ceramic matrix composite (CMC) such as an SiC—SiC composite). In such a situation, if needed, a bondcoat typical for such substrate may be used.

The use of “first”, “second”, and the like in the following claims is for differentiation within the claim only and does not necessarily indicate relative or absolute importance or temporal order. Similarly, the identification in a claim of one element as “first” (or the like) does not preclude such “first” element from identifying an element that is referred to as “second” (or the like) in another claim or in the description.

Where a measure is given in English units followed by a parenthetical containing SI or other units, the parenthetical's units are a conversion and should not imply a degree of precision not found in the English units.

One or more embodiments have been described. Nevertheless, it will be understood that various modifications may be made. For example, when applied to an existing baseline configuration, details of such baseline may influence details of particular implementations. Accordingly, other embodiments are within the scope of the following claims.

1. A ceramic coating (30) comprising:
matrix comprising oxide(s) of one or more matrix tetravalent elements; and
stabilizer comprising oxides of at least two stabilizer trivalent elements,
wherein:
the matrix elements are selected from a first group consisting of Zr, Hf, Ti, and Ce;
the stabilizer elements are selected from a second group consisting of La, Ce, Pr, Nd, Sm, Eu, Gd, Tb, Dy, Ho, Er, Tm, Yb, Lu, Y, and Sc;
the oxides of the first group represent 30% to 70% single cation mole percent of the ceramic coating;
the oxides of the second group represent 30% to 70% single cation mole percent of the ceramic coating;
the combined oxides of the first and second groups matrix and stabilizer represent at least 90 weight percent of the coating; and
in the entirety of a temperature range of 1000° K to 2000° K the coating has:
at least 50 volume percent flourite phase;
a ratio of average stabilizer ionic radius to average matrix ionic radius is 1.430 to 1.450 with a stabilizer coordination number of eight and matrix coordination number of six; and
a disorder factor of the stabilizer is at least 0.020 measured as an average of the absolute value of the difference between a given said stabilizer ionic radius and the average said matrix ionic radius multiplied by the single-cation mole percentage that given stabilizer is of the overall stabilizer content.

2. The ceramic coating of claim 1 wherein the stabilizer elements comprise:
one or more large stabilizer elements defined as each having a ratio of said stabilizer ionic radius to average said matrix ionic radius of greater than or equal to 1.465 and forming at least 25.0 single cation mole percent of the stabilizer; and
one or more small stabilizer elements defined as each having a ratio of said stabilizer ionic radius to average said matrix ionic radius of less than or equal to 1.415 and forming at least 25.0 single cation mole percent of the stabilizer.

3. The ceramic coating of claim 2 wherein the stabilizer elements comprise:
one or more intermediate stabilizer elements defined as each having a ratio of stabilizer ionic radius to average matrix ionic radius of >1.415 and <1.465 and forming at least 5.0 single cation mole percent of the stabilizer.

4. The ceramic coating of claim 1 wherein in the entirety of the temperature range of 1000° K to 2000° K the coating has:
at least 90 volume percent flourite phase.

5. The ceramic coating of claim 1 wherein:
zirconium is the largest by single cation mole percent of the matrix elements; and
erbium is one of the two largest by single cation mole percent of the stabilizer elements.

6. The ceramic coating of claim 5 wherein:
samarium or europium is the other of the two largest by single cation mole percent of the stabilizer elements.

7. The ceramic coating of claim 5 wherein:
hafnium is the second largest by single cation mole percent of the matrix elements.

8. The ceramic coating of claim 1 wherein:
hafnium is the largest by single cation mole percent of the matrix elements; and
yttrbium and/or erbium is one of the two largest by single cation mole percent of the stabilizer elements.

9. The ceramic coating of claim 1 wherein:
zirconium or hafnium is the largest by single cation mole percent of the matrix elements; and
yttrbium and/or erbium is one of the two largest by single cation mole percent of the stabilizer elements.

10. The ceramic coating of claim 1 wherein:
zirconium is the largest by single cation mole percent of the matrix elements; and
ytterbium is one of the two largest by single cation mole percent of the stabilizer elements

11. The ceramic coating of claim 1 wherein:
the ratio of average stabilizer ionic radius to average matrix ionic radius is 1.435 to 1.445; and
the disorder factor of the stabilizer is not more than 0.140.

12. (canceled)

13. The ceramic coating of claim 11 wherein:
the disorder factor is 0.025 to 0.065.

14. The ceramic coating of claim 1 wherein:
at least four of the stabilizer elements each form at least 4.0 single cation mole percent of the stabilizer; and
said at least four include at least one of erbium and ytterbium.

15. The ceramic coating of claim 1 wherein:
the ceramic coating has a thickness of at least 25 micrometers.

16. A gas turbine engine component (20) including the ceramic coating of claim 1 and further comprising:
a substrate (22);
a bondcoat (26) between the substrate and the ceramic coating; and
a YSZ layer (28) between the bondcoat and the ceramic coating.

17. (canceled)

18. (canceled)

19. A method for manufacturing the ceramic coating of claim 1, the method comprising:
EB-PVD of a base ceramic layer; and
EB-PVD from an ingot blend of the oxide(s) of one or more matrix elements and the oxides of at least two stabilizer elements.

20. (canceled)

21. (canceled)

22. (canceled)

23. (canceled)

24. (canceled)

25. (canceled)

26. (canceled)

27. (canceled)

28. A coated article (20) comprising:
a substrate (22);
a bond coat (26) deposited on the substrate; and
a mixed stabilizer layer (30) positioned over the bond coat and comprising matrix oxide(s) of one or more matrix tetravalent elements and stabilizer oxides of at least two stabilizer trivalent elements,
wherein:
the matrix elements are selected from a first group consisting of Zr, Hf, Ti, and Ce; and the stabilizer elements are selected from a second group consisting of La, Ce, Pr, Nd, Sm, Eu, Gd, Tb, Dy, Ho, Er, Tm, Yb, Lu, Y, and Sc; and
the mixed stabilizer layer has a thickness of at least 100 micrometers.

29. (canceled)

30. (canceled)

31. (canceled)

32. The coated article of claim 28 wherein:
at least four of the stabilizer elements each form at least 4.0 single cation mole percent of the stabilizer; and
said at least four include at least one of erbium and ytterbium.

33. The coated article of claim 28 wherein:
zirconium is the largest by single cation mole percent of the matrix elements; and
erbium is one of the two largest by single cation mole percent of the stabilizer elements.

34. (canceled)

35. (canceled)

36. (canceled)

37. (canceled)

38. (canceled)

39. (canceled)

40. A method for manufacturing a coated article (20), the method comprising:
depositing a bond coat (26) on a substrate (22); and
depositing a mixed stabilizer layer (30) over the bond coat and comprising matrix oxide(s) of one or more matrix tetravalent elements and stabilizer oxides of at least two stabilizer trivalent elements,
wherein:
the matrix elements are selected from a first group consisting of Zr, Hf, Ti, and Ce; and the stabilizer elements are selected from a second group consisting of La, Ce, Pr, Nd, Sm, Eu, Gd, Tb, Dy, Ho, Er, Tm, Yb, Lu, Y, and Sc;
the stabilizer oxides correspond to the stabilizers of at least one example of Table I without reference to concentration but each present in at least 5.0 single cation mole percent; and
the mixed stabilizer layer has a thickness of at least 100 micrometers.

41. (canceled)

42. (canceled)

43. (canceled)
